(19) United States
(12) Patent Application Publication
(10) Pub. No.: US 2024/0403603 A1
(43) Pub. Date: Dec. 5, 2024

(54) REDUCING LATENCY THROUGH PROPENSITY MODELS THAT PREDICT DATA CALLS

(71) Applicant: PAYPAL, INC., San Jose, CA (US)

(72) Inventors: Miguel Fernandez-Montes Cuberta, San Francisco, CA (US); Ashwin Rao Gopalkrishna, San Francisco, CA (US); Gayathri Baskaran, Santa Clara, CA (US); Ashok Subash, Chennai (IN); Suraj Arulmozhi, Chennai (IN); Krishna Kunal, Chennai (IN); Venkata Siva Kumar Tadi, Tanuku (IN); Logasundari Vinayagam, Fremont, CA (US); Mohammad Ahmadpoor, Chicago, IL (US)

(21) Appl. No.: 18/326,396

(22) Filed: May 31, 2023

(51) Int. Cl. G06N 3/0442; G06N 3/08

(52) U.S. Cl. CPC G06N 3/0442; G06N 3/08

(57) ABSTRACT

There are provided systems and methods for reducing latency through propensity models that predict data calls. A service provider, such as an electronic transaction processor for digital transactions, may provide computing services to users including those for electronic transaction processing. In order to provide sequence-based forecasting of computing events and processing requests for users, accounts, and/or activities associated with the service provider, the service provider may provide a machine learning model, such as a deep neural network, that predicted potential occurrences and likelihoods of computing events occurring at future times. When predicting the events, the service provider's machine learning predictive framework may further predict data calls required to be executed to retrieve data needed for processing during the events. These predicted calls may then be batched together into a batch processing job, which may be executed to retrieve the data prior to the predicted events.

### TECHNICAL FIELD

The present application generally relates to deep neural network (DNN) and other machine learning (ML) models, and more particularly to reducing latency of computing services by predicting and forecasting external data calls using encoded sequences for past events.

### BACKGROUND

Online service providers may provide services to different users, such as individual end users, merchants, companies, and other entities. For example, online transaction processors may provide electronic transaction processing services. When providing these services, the service providers may provide an online platform that may be accessible over a network, which may be used to access and utilize the services provided to different users. When utilizing these services, users (including customers, merchants, and other entities) may request data processing where data calls, such as application programming interface (API) calls, requests, responses, and the like, may be made to internal and/or external resources. This may be used to fetch, load, and/or process data, such as by retrieving data from an internal or external data source. Calls to data sources, especially external data sources over a network and/or from remote or disparate computing systems, may introduce latency and take significant time for those sources and systems to respond and provide data or other call processing services. However, calls to certain services and data sources may be aimed to improve one or more aspects of computing service quality provided to users (e.g., authorization rate, cost, security, etc.), and therefore the service provider may require calls to external services, which increase processing latency especially when performed in real time. Thus, there may exhibit a trade-off between performance and latency when performing external data calls.

Further, traditional temporal and time series forecasting is challenging due to issues with variability of temporal data, which may change due to short-term trends, seasonal factors, long-term trends, and other external factors. Conventional temporal and time series forecasting suffers from issues in accuracy due to these challenges and may not adequately consider certain factors and/or temporal data. Even small inaccuracies in forecasting may have significant effects when predicting actionable data. Therefore, there is a need for more accurate and efficient intelligent systems for predicting future data calls in order to minimize the latency impact of highly beneficial data calls involving calls to external services, which allow for adoption and benefits of such services without affecting user experiences, latency and processing speeds, service level agreements (SLAs), and other time sensitive considerations.

### BRIEF DESCRIPTION OF THE DRAWINGS

FIG. 1 is a block diagram of a networked system suitable for implementing the processes described herein, according to an embodiment;

FIG. 2 is an exemplary system architecture for training and deploying a deep neural network or other model for sequence-based forecasting of future external data calls, according to embodiments;

FIG. 3 is an exemplary deep neural network used for sequence-based forecasting and predicting of external data calls for retrieving and precaching data, according to an embodiment;

FIG. 4 is a flowchart for reducing latency through automated sequence-based propensity models that predict external data calls, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for reducing latency through automated sequence-based propensity models that predict external data calls. Systems suitable for practicing methods of the present disclosure are also provided.

In networked computing systems, such as online platforms and systems for service providers, electronic platforms and computing architectures may provide computing services to users and their computing devices. For example, online transaction processors may provide computing and data processing services for electronic transaction processing between two users or other entities (e.g., groups of users, merchants, businesses, charities, organizations, and the like). In order to assist in providing computing services to users, customers, merchants, and/or other entities, services providers may provide predictive forecasting of data calls and other requests and responses needed from different computing systems, for example, internal and/or external data systems, services, databases, and other sources, where external services may be of particular importance due to increased latency. In some embodiments, the service provider, such as an online transaction processor, may perform necessary external calls before the event of interest (e.g., a transaction requested to be processed with another entity, such as a transaction between a merchant and a customer) takes place. This may be regarded as a preprocessing step, where data may be retrieved from a database or requested to be preprocessed by a processor and returned to the service provider prior to the event of interest being processed and performed via the service provider's computing systems. However, with the size of a service provider's customer base, a naïve approach of performing this preprocessing step for all existing entities (e.g., merchants, customers, accounts, credit cards, etc.) may be impossible or prohibitively costly in terms of computing resource usage. Thus, to enable valuable but feasible preprocessing, the service provider may instead periodically select a relatively small set of entities and data for events of interest that should be preprocessed, cached, and/or loaded for later data processing during the specific event or other requested data processing operations.

However, time and sequence-based forecasting for predictive decision making is difficult and prone to error. Thus, service providers may not properly train and tune conventional DNN and other ML models for proper sequence-based forecasting of predictive data calls needed by computing services when processing events and other requests by users. The service provider may develop, train, test, and/or deploy a deep learning predictive model to forecast which entities (for example, credit cards, users or bank accounts, merchant accounts, etc.) may be most likely to take a given action in a specified time window, and therefore should be prioritized for preprocessing, caching, and/or loading of data for a future potential event or data processing request. The model may use, as input, a history of past events of interest for a given entity, encoded as a sequence, and output a probability of that entity experiencing the same or similar event within a specific time frame. In some embodiments, a neural network may combine one-dimensional convolutional layers and recurrent layers for predictive analysis and outputs. The architecture allows for further modifications, such as different output types (regression, classification, etc.) or recurrent cells (long-short term memory (LSTM), gated recurrent unit (GRU), other recurrent neural network (RNN), etc., cells that may have an input, output, and forget gate) allowing for controlling of information in the hidden layers of the neural network. Thereafter, for implementation and execution of the predictive models and engines, an infrastructure may seamlessly integrate the model's predictions with downstream services that are responsible for making the necessary preprocessing external calls based on predictive outputs. For example, the infrastructure may provide and/or be implemented as pluggable modules or other software and/or hardware components that may be integrated into real-time and/or batch processing systems for executing data calls. The pluggable modules may therefore include operations to integrate with the downstream services to predict data calls and then batch execute those data calls prior to a predicted event. These modules may then be used to load and/or provide the cached or otherwise stored data from the data calls at the time of the event.

Based on the predictions from the respective models, entities with a higher propensity for occurrence of an event may be identified and published through a messaging queue, which then may be mirrored for consumption and use by a relevant gateway computing service. In one example where credentials may be needed from an external computing service, the credentials for the entity may be fetched (e.g., bank, account, or payment card balance for customers, cryptogram credentials for tokens, merchant balance and/or financial account for merchants, etc.) and vaulted in a database or short term data cache, which may subsequently be leveraged at the time or occurrence that a real-time data call may be required and/or made for accessing the entity's data. In such an example, the latency incurred from interactions with external systems in live production computing systems and environments in then reduced. This may be run periodically, such as hourly, daily, or the like, thereby outputting a subset of entities that should be prioritized for preprocessing during that given period. Thus, the service provider allows for performing decision-making and predictions at future times and/or timesteps in order to provide actionable decisions on data needed, loaded, and/or processed for extensions of computing services and the like. In order to do so, a service provider may utilize neural networks (NNs), DNNs including LSTM, GRU, or other RNN architectures, ML models, and/or other artificial intelligence (AI) systems.

For example, a service provider may provide electronic transaction processing to users and entities through digital accounts, including consumers and merchants that may wish to process transactions and payments and/or perform other online activities. The service provider may also provide computing services, including email, social networking, microblogging, media sharing, messaging, business and consumer platforms, etc. In order to establish an account, these different users may be required to provide account details, such as a username, password (and/or other authentication credential, such as a biometric fingerprint, retinal scan, etc.), and other account creation details. The account creation details may include identification information to establish the account, such as personal information for a user, business or merchant information for another entity, or other types of identification information including a name, address, and/or other information. The entity may also be required to provide financial or funding source information, including payment card (e.g., credit/debit card) information, bank account information, gift card information, benefits/incentives, and/or financial investments, which may be used to process transactions. The online payment provider may provide digital wallet services, which may offer financial services to send, store, and receive money, process financial instruments, and/or provide transaction histories, including tokenization of digital wallet data for transaction processing. The application or website of the service provider, such as PayPal® or other online payment provider, may provide payments and the other transaction processing services.

An online transaction processor or other service provider may execute operations, applications, decision services, and the like that may be used to process transactions between two or more users or entities. When providing computing services to users or other entities, as well and making other business decisions, the service provider may utilize intelligent sequence-based forecasting based on historical data of past events requested and/or processed by users (e.g., customers, merchants, and other entities of a service provider) in a predictive manner. Initially, the service provider may train a DNN or other ML model for a predictive output or classification associated with one or more future times, timesteps, and/or events (and their corresponding future predicted time of occurrence, such as falling within a future time period). In order to train the DNN or other ML models, training data for the models may be collected and/or accessed. The training data may correspond to a set or collection of features from some input data records, which may be associated with users, accounts, activities, events, external computing services, entities, and the like. The training data may further have a temporal factor or dimension, such as when the events or data of interest occurred during or over a time period and/or having data related to specific points in time or timesteps (e.g., intervals or time period, which may be part of a longer time period, such as hours of a day, a day of the week or month, etc.).

The training data may be collected, aggregated, and/or obtained for a particular predictive output and/or classifications by the DNN. For example, a DNN may be associated with providing predictive forecasts of a user's, business entity's, or account's future behavior, activity, actions, incoming or outgoing funds or data, value, engagement, or the like. In some embodiments, the DNN may be used to classify users with the service provider (e.g., based on past behaviors and the like), if users are predicted to engage in or be the victim of fraud, an entity's future value, and the like. The training data may therefore have data records, where the data records may correspond to particular past times of the events or data processing requests, and therefore have a temporal factor or dimension. The training data may also include multiple data records for different times and events over a time period, which allows for analysis of the temporal data over a time period and learning to predict future events.

Conventional sequence-based and time forecasting by service providers may be inaccurate or have difficulties properly processing and training on time and sequence-based data. As discussed herein, a service provider may utilize a DNN model and/or framework to provide deep temporal and sequence-based forecasting of future predicted data processing events potentially occurring and/or being requested by one or more entities (e.g., users including customers or merchants/sellers of an online transaction processor). The DNN model may use an LSTM recurrent neural network architecture for future forecasting and execution of predictive data calls in batched data processing operations. Other NN, ML, and/or AI systems and models may also be used. The DNN model may be trained for a predictive score, classification, or output variable associated with input features, where the output is associated with a predictive forecast. The predictive forecast may be associated with one or more main input variables or features, such as past data for event occurrence, time of occurrence, pattern of occurrence, or the like. The predictive output, such as the score, decision, or other value, may further be used to predict other information associated with an account, user, activity, or the like based on the training data. Thereafter, a recommendation, action, or assessment may be provided that may be associated with additional computing services, information, value, and the like for users, accounts, and/or entities.

When training the DNN model, such as the LSTM, GRU, or other RNN model, training data and data sets (e.g., data records for past or historical data events, patterns, occurrences, and other recorded information) may be selected and/or determined. The training data may be associated with the predictive task that the model or network is being trained for, such as prediction of whether an event may occur at a future time, during a future time period, and/or during/after a future timestep occurs. In this regard, an LSTM training framework may be used to train an LSTM model, where, during training, operations may be performed in order to optimize the LSTM or other DNN model for pattern or sequence-based forecasting and/or predicting of future events. Training may be done by creating mathematical relationships based on the DNN or LSTM algorithm to generate predictions and other outputs, such as a predictive score or classification, for a future forecast of an event potentially occurring at a future time, as well as likelihood or probability of occurring. The DNN model trainer may perform feature extraction to extract features and/or attributes used to train the DNN model from the training data. For example, training data features may correspond to those data features which allow for value determinations and/or outputs by nodes of a DNN model, which may be used in the final predictive output, score, or classification.

In this regard, a feature may correspond to data that may be used to output a decision by a particular node, which may lead to further nodes and/or output decisions by the DNN model. The LSTM model may be used in order to provide a temporal dimension to the input feature data and corresponding features or variables. The features may also correspond to a sequence of events and/or sequence of actions, occurrences, and the like that occur leading up to and/or causing an event (e.g., when a transaction occurs, events such as webpage browsing, item addition to digital carts, price checks and/or coupon application, etc., that lead up to requesting transaction processing). Thus, training data patterns and/or data records may be encoded into sequences for an event, where one or more different pieces of data and/or records may be combined and/or used to generate a sequence as one or more input features for training of DNNs and other ML models, as well as later predicting of future events at future times or timesteps based on occurrences of other actions, occurrences, events, or the like with the entity (e.g., real-world or digital activities that occur by or with the entity). However, the training data may also be tailored to and/or utilized for training other DNNs and ML models that provide sequence-based future forecasting and predictions, such as at one or more future times or timesteps. Further, data preprocessing steps with the training data may be utilized to format the data for data ingestion during model or network training. Once trained, the DNN model may be deployed for time and series-based forecasting of future events.

Predictive forecasts, classifications, and outputs may then be generated based on input feature data for a user, account, entity, or the like. The predictive forecasts may be to forecast a variable, trait, feature, or some other data for the user, account, entity, or the like at a future time or timestep. This may be used for different purposes. For example, with a business entity or merchant, a future potential transaction event or the like may be forecasted as potentially occurring (as well as a likelihood of occurring) at a future time or during or after a future timestep. Similarly, for customers, future transactions may be forecasted, as well as other future events a merchant or customer may take with an account, website, application, or the like. The predictive forecasts may also include forecasts of e-commence events and the like, as well as other online resource usage, including predictions for computing resource availability and bandwidth usage, social media or networking platform usage, media posting or viewing, data transmissions, account login or authentication, user and/or device validation, and the like. Thus, the service provider may provide automated and intelligent sequence-based forecasting in a more accurate manner. By performing better sequence-based forecasting of future events, the service provider may provide improved predictive services and data processing systems through intelligent DNN model performance.

For example, a DNN or another ML model trained as discussed herein may be used for a network token cryptogram prefetch. Network token processing may correspond to processing of card transactions that serves as an alternative to the traditional processing via primary account number (PAN) and card verification value (CVV), which may provide benefits in terms of authorization rates, risk, and transaction expense. Token processing via network token cryptograms may require a newly generated cryptogram for each transaction, where fetching this cryptogram from the card network adds latency to the full transaction flow. A trained DNN or other ML model that utilizes sequence-based encoding of input features may be utilized to predict cryptogram use and preprocess/load the cryptogram in order to enable card token processing via cryptograms with benefits to authorization rate and risk while minimizing the latency from fetching the necessary cryptograms. More specifically, the service provider may apply sequence-based propensity models to credit cards transaction histories in order to prefetch the cryptograms of those cards that are likely to have a transaction within a future time period.

Similarly, the DNN or other ML model trained as discussed herein may be used with bank transactions and OpenBanking risk decisioning. OpenBanking may refer to the use of open APIs for developers that allow access to financial data. In this regard, a bank account balance may be utilized for risk decisioning by determining if a potentially risky customer has enough bank balance before a transaction, and therefore whether the transaction should be allowed. Generally, a bank account balance may be unknown to an online transaction processor, but may be increasingly available and relevant through OpenBanking technology by calling third-party services. Performing these calls to the OpenBanking data providers, however, may increase transaction latency. Prefetching the balance of all bank accounts registered by the transaction processor would not be feasible or be cost prohibitable in terms of computing resource usage and the like. However, the DNN or other ML model may be used to determine and prioritize which bank account balances should be prefetched daily based on a likelihood of each account to be used in a transaction in the short-term future (e.g., within that day or other time period or timestep). This allows risk teams to know the balance of those risky users who are likely to transact and thus make a more informed risk decision without latency overhead.

Once the training data set(s) has/have been generated, identified, and/or determined, the training data for a DNN model may be used to train the DNN model using a DNN training architecture and framework. The service provider may also provide a general framework for event prediction coupled with an infrastructure to publish these predictions to any relevant downstream processes. The framework may be implemented as pluggable modules that allow use with downstream data processing services to predict calls needed by events and execute those calls, thereby making data available in a predictive manner and reducing latency at the time of data processing and execution of data requests and other calls for an event. The pluggable modules may be used to select the entities (merchants, users, etc.) that should receive priority treatment in the form of pre-processing, thus enabling improved payments processing. For example, the service provider may use intelligent decision-making operations from the pluggable modules or other operations of the framework to attempt to forecast and/or predict data for customers, merchants, and other entities. The models and networks may be integrated into an architecture where the predictions may then be acted on by executing the calls in a batch processing event and by a batch processor at a specific time. This may be done in a predictive manner so that the external calls and data are prefetched and preprocessed for future usage in a predictive manner.

The time may be selected based computing resource usage and/or availability, bandwidth, network resource consumption, processor availability, external service availability, and other computing resource and processing capabilities and consumption. This allows for optimizing execution of calls to certain computing services, such as external API calls, to be batch executed at efficient or optimized times, where data is prefetched, cached, and/or loaded for future usage. Further, the batch processing may be done in a single or reduced number of processing events or operations in order to further reduce computing resource usage and further enhance efficiency and speed in call execution and data retrieval, processing, and loading.

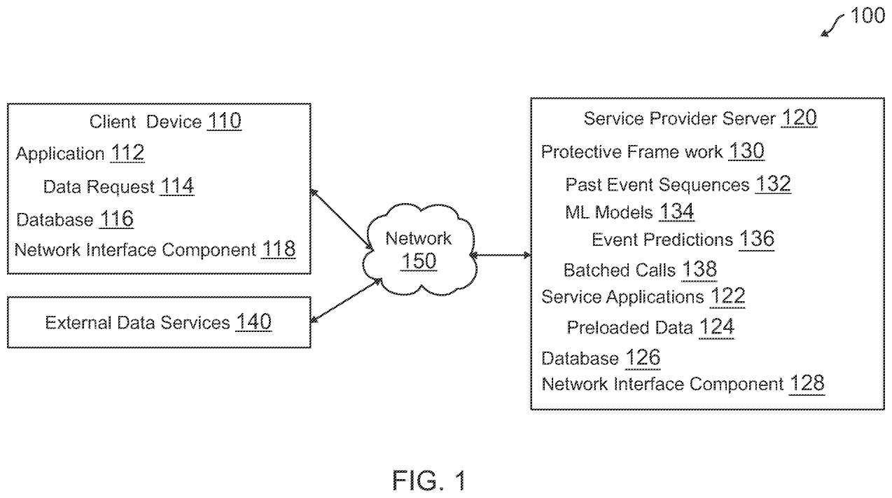

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 1 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entity.

System 100 includes a client device 110, a service provider server 120, and external data services 140 in communication over a network 150. Client device 110 may be utilized by users or other entities to interact with service provider server 120 over network 150, where service provider server 120 may provide various computing services, data, operations, and other functions over network 150 that may include use of data from external data services 140. In this regard, client device 110 may perform activities with service provider server 120 for account establishment and/or usage, electronic transaction processing, and/or other computing services. Service provider server 120 may receive feature data for a DNN model or system that corresponds to data records associated with a user, account, or the like. Service provider server 120 may provide sequence-based forecasting of events for an entity using a DNN model or system, such as an LSTM architecture network, that is trained for predicting an event and external calls to external data services 140 that are required for processing of the event. Service provider server 120 may then include a batch processor for processing of external API calls and the like to external data services 140 in a batch processing event prior to needing the data from the external calls and/or executing the external calls with external data services 140 when the event occurs and/or is being processed.

Client device 110, service provider server 120, and external data services 140 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 150.

Client device 110 may be implemented as a computing and/or communication device that may utilize appropriate hardware and software configured for wired and/or wireless communication with service provider server 120. For example, in one embodiment, client device 110 may be implemented as a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data. Although only one client computing device is shown, a plurality of client computing device may function similarly.

Client device 110 of FIG. 1 contain an application 112, a database 116, and a network interface component 118. Application 112 may correspond to executable processes, procedures, and/or applications with associated hardware. In other embodiments, client device 110 may include additional or different modules having specialized hardware and/or software as required.

Application 112 may include one or more processes to execute software modules and associated components of client device 110 to provide features, services, and other operations to a user from service provider server 120 over network 150, which may include account, electronic transaction processing, and/or other computing services and features from service provider server 120. In this regard, application 112 may correspond to specialized software utilized by users of client device 110 that may be used to access a website or application (e.g., mobile application, rich Internet application, or resident software application) that may display one or more user interfaces that allow for interaction with service provider server 120, for example, to access an account, process transactions, and/or otherwise utilize computing services. In various embodiments, application 112 may correspond to one or more general browser applications configured to retrieve, present, and communicate information over the Internet (e.g., utilize resources on the World Wide Web) or a private network. For example, application 112 may provide a web browser, which may send and receive information over network 150, including retrieving website information, presenting the website information to the user, and/or communicating information to the website. However, in other embodiments, application 112 may correspond to a dedicated application of service provider server 120 or other entity (e.g., a merchant) for transaction processing via service provider server 120. Thus, application 112 may be used to transmit or provide a data request 114 to service provider server 120 for data processing, which may utilize external data services 140 during data processing. For example, data request 114 may include a request for a data processing event that uses data from external data services 140.

Application 112 may utilize, process, and/or provide account information, user financial information, and/or transaction histories for electronic transaction processing, including processing transactions using financial instrument or payment card data. Application 112 and/or another device application may be used to request data processing of data request 114 using data from external data services 140 that may be forecasted for future API calls and other data requests. Prior data requests and other data processing events may be used to train DNN models, such as using a LSTM recurrent neural network architecture. The training data may include one or more data records, which may be stored and/or persisted in a database and/or data tables accessible by service provider server 120. The training data may be used for sequence-based forecasting of a trait, variable, feature, or the like at a future time and/or timestep based on past sequences of events. Thus, data request 114 may be forecasted prior to execution and/or provision to service provider server 120 for processing. When forecasted, data from external data services 140 that is required for processing with data request 114 may be prefetched, retrieved, loaded, and/or stored prior to occurrence of data request 114 using one or more API calls or other data requests to external data services 140. This may be done through batched processing events, jobs, and/or tasks for the predicted external data calls to external data services 140 by service provider server 120.

Additionally, application 112 may be used to view the results of processing data request 114 and/or other forecasting and processing of requests and events by service provider server 120. In this regard, application 112 may be used for one or more data processing tasks, such as electronic transaction processing. Application 112 may be utilized to enter, view, and/or process items the user wishes to purchase in a transaction, as well as perform peer-to-peer payments and transfers. In this regard, application 112 may provide transaction processing through a user interface enabling the user to enter and/or view the items that the users associated with client device 110 wish to purchase. Thus, application 112 may also be used by a user to provide payments and transfers to another user or merchant, which may include transmitting data request 114 to service provider server 120. For example, accounts and electronic transaction processing may include and/or utilize user financial information, such as credit card data, bank account data, or other funding source data, as a payment instrument when providing payment information to service provider server 120 for the transaction. Additionally, application 112 may utilize a digital wallet associated with an account with a payment provider as the payment instrument, for example, through accessing a digital wallet or account of a user through entry of authentication credentials and/or by providing a data token that allows for processing using the account. Application 112 may also be used to receive a receipt or other information based on transaction processing. Further, additional services may be provided via application 112, including social networking, media posting or sharing, microblogging, data browsing and searching, online shopping, and other services available through service provider server 120.

Client device 110 may further include database 116 stored on a transitory and/or non-transitory memory of client device 110, which may store various applications and data and be utilized during execution of various modules of client device 110. Database 116 may include, for example, identifiers such as operating system registry entries, cookies associated with application 112 and/or other applications, identifiers associated with hardware of client device 110, or other appropriate identifiers, such as identifiers used for payment/user/device authentication or identification, which may be communicated as identifying a user and/or client device 110 to service provider server 120. Moreover, database 116 may store data used for training of LSTM and/or other DNN models, as well as results from forecasted events and/or data processing by service provider server 120.

Client device 110 includes at least one network interface component 118 adapted to communicate with service provider server 120 and/or another device or server. In various embodiments, network interface component 118 may each include a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency, infrared, Bluetooth, and near field communication devices.

Service provider server 120 may be maintained, for example, by an online service provider, which may provide computing services including account and electronic transaction processing services. In this regard, service provider server 120 includes one or more processing applications which may be configured to interact with client device 110 to provide computing and customer services based on sequence-based forecasting using a DNN model. In various embodiments, use of the forecasting may be used to execute data calls in a predictive manner and process data requests to provide information, messages, and/or computing services to users and other entities of service provider server 120. In one example, service provider server 120 may be provided by PAYPAL®, Inc. of San Jose, CA, USA. However, in other embodiments, service provider server 120 may be maintained by or include another type of service provider.

Service provider server 120 of FIG. 1 includes a predictive framework 130, service applications 122, a database 126, and a network interface component 128. Predictive framework 130 and service applications 122 may correspond to executable processes, procedures, and/or applications with associated hardware. In other embodiments, service provider server 120 may include additional or different modules having specialized hardware and/or software as required.

Predictive framework 130 may correspond to one or more processes to execute modules and associated specialized hardware of service provider server 120 to provide computing services to users including use of sequence and/or time-based forecasting of required data and corresponding executable data calls prior to occurrences of events requiring such data. In this regard, predictive framework 130 may correspond to specialized hardware and/or software used by a user associated with client device 110 to utilize one or more services for sequence-based forecasting using one or more DNN models including LSTM architectures based on input feature data having data records associated with events occurring during past times or timestep during a time period (e.g., series of timestamps or timesteps for the events occurring in a time period). The events may be associated with data processing requests, actions, activities, or the like that occur for a user, account, entity, device, or the like. In this regard, predictive framework 130 may utilize DNN models, such as ML models 134 having trained layers based on training data and selected ML features or variables, to determine and output event predictions 136. Using event predictions 136, batched calls 138 may then be executed prior to occurrences and/or predicted times of event predictions 136, which may retrieve, load, and/or store the data to long-term or short-term storage, such as a database or data cache, respectively. Batched calls 138 may correspond to one or more individual data calls that have been grouped, collected, and/or aggregated into a batch processing job for execution at a scheduled time, after a set time period, and/or in response to another event or action (e.g., detection of a user login, availability of server or network resources, processor load and/or availability, etc.). Thus, batched calls 138 may correspond to data calls, such as API requests or other API calls to external data services 140 and have corresponding API responses from external data services 140. In other embodiments, batched calls 138 may also include data calls and requests to other internal data services, databases, resources, and the like.

In this regard, ML models 134 may initially be trained using training data determined and/or extracted from data tables and/or data records for corresponding features or variables selected for training of ML models 134 and decision-making during execution of ML models 134. For example, ML features or variables may correspond to individual pieces, properties, characteristics, or other inputs for an ML model and may be used to cause an output by that ML model once the ML model has been trained using data for those features from training data. ML models 134, once trained, may be used for sequence-based forecasting of a trait, feature, variable, or other information based on ML layers that are trained and optimized. ML models 134 may be trained to provide a predictive output, such as a score, likelihood, probability, or decision, associated with a particular prediction, classification, or categorization of a future forecast for data associated with a user, account, entity, activity, or the like. For example, ML models 134 may include DNN, ML, or other AI models trained using training data having data records that have columns or other data representations and stored data values (e.g., in rows for the data tables having feature columns) for the features. When building ML models 134, training data may be used to generate one or more classifiers and provide recommendations, predictions, or other outputs for sequence-based forecasting of predictive forecasts of events potentially occurring at a future time (e.g., based on a likelihood of occurrence) based on those classifications and an ML or NN model algorithm and architecture. Such determination of event predictions 136 may be used to forecast individual API calls or other data requests and calls to external data services 140 or other data resources for required data during data processing of the event. The data calls may incur or add additional latency to data processing, for example, caused by the delay or lag with network communications and data processing, which slows the corresponding processing of the event. Thus, by executing those data calls prior to event predictions 136 occurring, such as by executing those calls in batched calls 138 prior to occurrences of the events predicted in event predictions 136, the data may be retrieved, loaded, stored, processed, and/or otherwise made available for data processing during those events and corresponding requests, which reduces system latency and delay caused by such data processing, network communications, server and/or processor availability, bandwidth, and the like.

The algorithm and architecture for training ML models 134 may correspond to an LSTM recurrent neural network architecture. Use of an LSTM architecture may provide benefits for temporal-based predictions for data that may change over a time period and/or predictions of future forecasts that may be time-sensitive to past temporal data. The training data may be used to determine features, such as through feature extraction and feature selection using the input training data. For example, DNN models for ML models 134 may include one or more trained layers, including an input layer, a hidden layer, and an output layer having one or more nodes, however, different layers may also be utilized. As many hidden layers as necessary or appropriate may be utilized and the hidden layers may include one or more layers used to generate vectors or embeddings used as inputs to other layers and/or models. This may simplify the input to different layers of ML models 134 for performing predictive forecasting. An output vector may be used as input without feature extraction being required by providing an embedding or vector that may be processed using the layers of ML models 134. In some embodiments, each node within a layer may be connected to a node within an adjacent layer, where a set of input values may be used to generate one or more output values or classifications. Within the input layer, each node may correspond to a distinct attribute or input data type for features or variables that may be used to train ML models 134, for example, using feature or attribute extraction with the training data.

Thereafter, the hidden layer(s) may be trained with this data and data attributes, as well as corresponding weights, activation functions, and the like using a DNN algorithm, computation, and/or technique. For example, each of the nodes in the hidden layer generates a representation, which may include a mathematical computation (or algorithm) that produces a value based on the input values of the input nodes. The DNN. ML, or other AI architecture and/or algorithm may assign different weights to each of the data values received from the input nodes. The hidden layer nodes may include different algorithms and/or different weights assigned to the input data and may therefore produce a different value based on the input values. The values generated by the hidden layer nodes may be used by the output layer node(s) to produce one or more output values for ML models 134 that attempt to classify and/or categorize the input feature data and/or data records (e.g., for a user, account, activity, event, etc., which may be a predictive score or probability for a predictive forecast of potential future events at future times). One-hot encoding may also be used with output scores to provide the output prediction or classification. Thus, when ML models 134 are used to perform a predictive analysis and output, the input data may provide a corresponding output for event predictions 136 based on the classifications trained for ML models 134.

Layers of ML models 134 may be trained by using training data associated with data records and a feature extraction of training features. By providing training data to train ML models 134, the nodes in the hidden layer may be trained (adjusted) such that an optimal output (e.g., a classification) is produced in the output layer based on the training data. By continuously providing different sets of training data and penalizing ML models 134 when the output of ML models 134 is incorrect, ML models 134 (and specifically, the representations of the nodes in the hidden layer) may be trained (adjusted) to improve its performance in data classifications and predictions, such as outputs of event predictions 136, which may also include predicted times and/or data calls for execution prior to event occurrence. Adjusting ML models 134 may include adjusting the weights associated with each node in the hidden layer.

The training data may be used as input data sets that allow for training ML models 134 to make classifications and predictive forecasts based on attributes and features. In some embodiments, past event sequences 132 may be used as the training data and/or the test data for testing trained models. Such data may be segregated and/or occur in time series so that test data occurs after the training data and may be used to test for valid event predictions. In further embodiments, past event sequences 132 may also or instead be used as input data to predict future events that have a sufficient likelihood of occurrence (e.g., meeting or exceeding a threshold for likelihood of occurrence) to execute API requests and calls prior to a predicted occurrence of the event, which may also have a predicted time, time window, or time period for occurrence. For example, once trained, past event sequences 132 may be used as input in order to determine event predictions 136. Past event sequences 132 may be processed based on corresponding ML features (e.g., one or more past sequences, which may be a time window for whether an event has occurred and/or other data associated with the occurrence or lack of occurrence of the event), and thereafter used as input that are relevant to the corresponding output forecasted event. Past event sequences 132 may include data associated with the features trained for ML models 134 and may therefore also include past data calls for those past events, which may be used to predict and/or execute data calls, as well as batch those data calls into batched calls 138 for a batch processing job. Using the sequence-based forecasting, a predictive forecast for a trait, feature, or variable for API call requirement for future events may be provided at one or more future times. The predictive forecast(s) of event predictions 136 and corresponding API calls in matched calls 138 may be used with service applications 122 in order to provide one or more services, offers, notification, or messages associated with the forecasted data. For example, by executing batched calls 138 prior to occurrences of event predictions 136, preloaded data 124 may be retrieved, loaded, preprocessed, cached, and/or stored prior to the events and for use by service applications 122 when such events occur.

Service applications 122 may correspond to one or more processes to execute modules and associated specialized hardware of service provider server 120 to process a transaction or provide another service to customers, merchants, and/or other end users and entities of service provider server 120. In this regard, service applications 122 may correspond to specialized hardware and/or software used by service provider server 120 to providing computing services to users, which may include electronic transaction processing and/or other computing services using accounts provided by service provider server 120. In some embodiments, service applications 122 may be used by users associated with client device 110 to establish user and/or payment accounts, as well as digital wallets, which may be used to process transactions. In various embodiments, financial information may be stored with the accounts, such as account/card numbers and information that may enable payments, transfers, withdrawals, and/or deposits of funds. Digital tokens for the accounts/wallets may be used to send and process payments, for example, through one or more interfaces provided by service provider server 120.

In this regard, digital tokens may be pre-generated, prefetched, or otherwise retrieved in a predictive manner from external data services 140 using predictive framework 130, which may provide preloaded data 124 for processing when events occur without or by reducing latency in obtaining such data. Such tokens may include network token cryptograms and the like. Preloaded data 124 may be accessible from an internal, local, or faster access resource, cache, database, or the like in a faster manner and by reducing usage of computing resources and processing requirements at high load times and/or during event processing. Other data may also be prefetched, preloaded, preprocessed, cached, and/or stored from external data services 140 prior to being required for data processing of an event and made available to service applications 122 as preloaded data 124. For example, the digital accounts may be accessed and/or used through one or more instances of a web browser application and/or dedicated software application executed by client device 110 and engage in computing services provided by service applications 122. Thus, preloaded data 124 may include data used for authentications, risk analysis, fraud detection, and the like for account access and/or account use.

In further embodiments, preloaded data 124 may be used with a computing service, such as for electronic transaction processing for payments, transfers, and the like with merchants, sellers, other users (e.g., peer-to-peer (PSP) payments and the like), and/or other entities. For example, bank data may be retrieved prior to being needed from external data services 140 by batched calls 138 and made available with preloaded data 124. Bank data from external data services 140 may be retrieved from OpenBanking or other open-source banking and/or computing infrastructure that provides available financial data. Computing services of service applications 122 may also or instead correspond to messaging, social networking, media posting or sharing, microblogging, data browsing and searching, online shopping, and other services available through service provider server 120. Thus, preloaded data 124 may be used for other computing services based on event predictions 136 for events that are likely to occur using such services by different users and/or entities.

Service applications 122 may also be desired in particular embodiments to provide features to service provider server 120. For example, service applications 122 may include security applications for implementing server-side security features, programmatic client applications for interfacing with appropriate application programming interfaces (APIs) over network 150, or other types of applications. Service applications 122 may contain software programs, executable by a processor, including a graphical user interface (GUI), configured to provide an interface to the user when accessing service provider server 120 via one or more of client device 110, where the user or other users may interact with the GUI to view and communicate information more easily. In various embodiments, service applications 122 may include additional connection and/or communication applications, which may be utilized to communicate information to over network 150.

Service provider server 120 further includes database 126. Database 126 may store various identifiers associated with client device 110. Database 126 may also store account data, including payment instruments and authentication credentials, as well as transaction processing histories and data for processed transactions. Database 126 may store financial information or other data generated and stored by predictive framework 130. Database 126 may also include data and computing code, or necessary components for ML models 134. Database 126 may also include training data, input, and/or feature data having data records for events and/or sequences of events, which may be processed by predictive framework 130 for sequence-based event predictions.

In various embodiments, service provider server 120 includes at least one network interface component 128 adapted to communicate client device 110, external data services 140, and/or other devices or server over network 150. In various embodiments, network interface component 128 may comprise a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency (RF), and infrared (IR) communication devices.

External data services 140 may correspond to one or more websites, applications, devices, servers and server systems, cloud computing platforms and storages, and other online resources to provide data to service provider server 120 in response to executed data calls and requests (e.g., API calls to APIs of external data services 140), which may provide information, computing services, products (e.g., items and/or services for sale), interactable features, and the like to users. In some embodiments, one or more of external data services 140 may be hosted, provided by, and/or utilized by a merchant, seller, or the like to advertise, market, sell, and/or provide items or services for sale, as well as provide checkout and payment. In this regard, external data services 140 may be utilized by one or more merchants to provide websites, applications, and/or online portals for transaction processing and sales. For example, external data services 140 may be used to host a website having one or more webpages that may be used by customers to browse items for sale and generate a transaction for one or more items. External data services 140 may provide a checkout process, which may be utilized to pay for a transaction. The checkout process may be used to pay for a transaction using a payment instrument, including a credit/debit card, and account with service provider server 130, or the like.

Further, one or more of external data services 140 may correspond to token service providers (TSPs), such as those that may provide and/or utilize network tokens and network token cryptograms for prefetching by service provider server 120. External data services 140 may also include or be associated with financial institutions and/or financial information, including OpenBanking platforms and/or data sources. In some embodiments, the processes, APIs and/or API integrations for data requesting and retrieval by service provider server may be based on one or more operations, software development kits (SDKs), API standards or guidelines, and the like that may be implemented in the corresponding computing service. External data services 140 may be utilized by customers and other end users to view one or more user interfaces, for example, via graphical user interfaces (GUIs) presented using an output display device of computing device 110.

Network 150 may be implemented as a single network or a combination of multiple networks. For example, in various embodiments, network 150 may include the Internet or one or more intranets, landline networks, wireless networks, and/or other appropriate types of networks. Thus, network 150 may correspond to small scale communication networks, such as a private or local area network, or a larger scale network, such as a wide area network or the Internet, accessible by the various components of system 100.

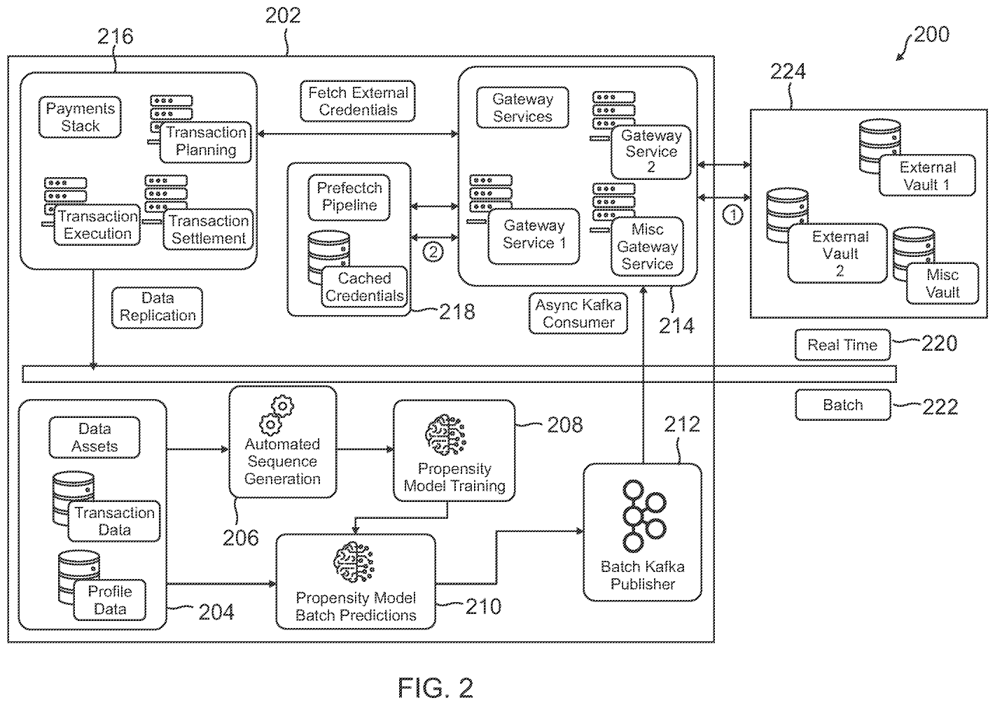

FIG. 2 is an exemplary system architecture 200 for training and deploying a deep neural network or other model for sequence-based forecasting of future external data calls, according to embodiments. System architecture 200 includes a service provider system 202 in communication with external systems 224, which may correspond generally to service provider server 120 and external data services 140, respectively, discussed in reference to system 100 of FIG. 1. In this regard, service provider system 202 may perform sequence-based forecasting and predicting of future events based on sequences of past events and other data using DNN and/or other ML models. In this regard, service provider server 120 may train and deploy one or more LSTM, DNN, or ML models, such as ML models 134 in system 100, to determine predictive forecasts of events at future times based on encoded sequences of events.

In system architecture 200, a real-time computing environment 220 and a batch computing environment 222 are shown that are utilized to execute data calls for retrieving, loading, and/or processing data prior to a need to requirement for an event predicted to occur at a future time. Prediction of the future events and required API request or other data requests and calls to external systems 224 may be performed using one or more trained ML models, such as an LSTM model or other DNN model that may batch process data calls in batch processing jobs for data, such as external credentials, tokens and/or cryptograms, financial data, and the like needed for electronic transaction processing, prior to use by the corresponding event. For example, with sequence-to-sequence (seq2seq) DNN models and predictions, such as an encoder-decoder model, a specific input set of sequence may be processed for a corresponding output of a predicted event based on those past sequences, such as by linking past times of event occurrences (e.g., past days of the week, months, seasons, or the like) with a corresponding future time. Sequences may be generated based on data assets 204 for past occurrence of events, such as transaction data and/or profile data for one or more accounts that perform electronic transaction processing. An automated sequence generator 206 may perform automated sequence generation by determining sequence of events or a predetermined time period (e.g., events that occur over a set number or series of timesteps, such as whether the event occurred on each of three days that are in sequence). These sequences from automated sequence generator 206 may then be provided as input for training of an LSTM model, DNN model, or other ML model using a propensity model training 208, which may be used to predict or forecast a future event of interest based on past sequences of the event's occurrence and/or other similar or related events or occurrences. Such processing may occur asynchronously from the predicting, forecasting, and/or processing of the event, such as during an offline and/or batch processing job and/or operation in batch computing environment 222.

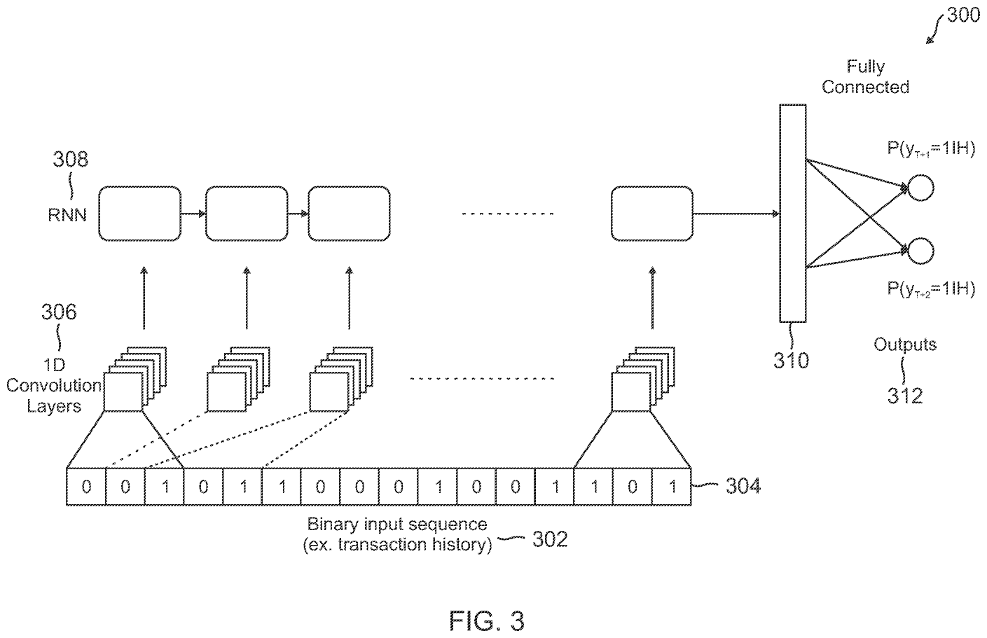

In this regard, propensity model training 208 may occur in order to provide future sequence-based and time series forecasting for events at future times. Training of the LSTM model, DNN model, or other ML model may be performed by extracting and/or generating input training features for sequences of input training events occurring in the past and training the ML model, as discussed further with regard to FIG. 3 below. Such training may occur offline and/or in batch computing environment 222 instead of real-time computing environment 220 to allow for additional time and computing resources to be used, as well as utilize offline and available processing resources while avoiding or minimizing impacting live and real-time computing resources and processing availability. After training, such models may be used to determine propensity model batch predictions 210, which may correspond to predicted events and predicted data calls required by such events. Thus, propensity model batch predictions 210 may include groups of API calls and other data requests that may be used to retrieve, load, process, and/or store data prior to being required by a predicted event, such as a predicted data processing request and/or job. A batch publisher 212 may then be used to publish these batch processing jobs for propensity model batch predictions 210 to real-time computing environment 220 for processing.

Thereafter, gateway services 214 may be used to execute the batch processing jobs from batch publisher 212 of API requests and calls that have been batched at specific times, when resources are made available, and/or prior to the times of the predicted occurrences of the events and requirement of the corresponding data. Gateway services 214 may interact with external system 224 in order to obtain the data being requested, fetched, and/or retrieved using the batched calls from batch publisher 212. External systems 224 may retrieve, process, and/or provide the data back to gateway services 214 for loading, processing, caching, storing, and/or otherwise making available for future use. Gateway services 214 may interact with a processing stack 216 and/or a prefetch pipeline 218 to retrieve, process, load, and/or otherwise provide data to processing stack 216 required for processing an event in real-time computing environment 220.

Gateway services 214 may execute the batched processing job prior to the predicted events based on predictions of needed to execute such data calls. In this regard, instead of gateway services 214 being required to execute calls to external systems 224 in real-time computing environment 220 and at the time of data requirement for processing a request, job, or event, gateway services 214 may prefetch the data and perform any additional data operations predictively to reduce latency, load times, data processing times, and consumed processing and network resources. Thus, gateway services 214 may not be required to execute data calls through an interaction 1, which may introduce latency and lag due to network communications and processing requirements with external systems 224. Instead, gateway services 214 may perform an interaction 2 whereby the data is retrieved from a local cache or other data storage, database, or the like for prefetch pipeline 218. This may then be loaded, processed, and provided to processing stack 216 faster and by avoiding the latency and lag issues introduced by interaction 1.

FIG. 3 is an exemplary deep neural network (DNN) 300 used for sequence-based forecasting and predicting of external data calls for retrieving and precaching data, according to an embodiment. DNN 300 includes a model having different layers trained from input training features to provide an output predictive forecast or classification at an output layer, which may be performed based on values or scores determined from the hidden layers of the model. In this regard, the output of the model for the DNN may be used for forecasting based on sequence-based inputs and the like.

DNN 300 includes a model having different layers trained from input training features to provide an output predictive forecast or classification at an output layer, which may be performed based on values or scores determined from the hidden layers of the model. In this regard, the output of the model for DNN 300 may be used for sequence-based forecasting of future events and required data calls for such events based on a main forecasted feature(s) of a future event or other variable or feature that may correspond to a user, account, trend, event, activity, or other data.

In this regard, DNN 300 process an input sequence 302 using an input layer, one or more hidden layers, and an output layer, which may provide a forecasted or predicted output, such as outputs 312. The input layer may correspond to a layer that takes input data for features, such as sequences event occurrences (as well as lack of occurrence or other event feature or variable) at times and/or timesteps of a sequence's time period or portion thereof. The data may be parsed and processed, and feature data for the particular features of DNN 300 extracted and used as main forecasted feature(s) at the input layer. Additionally, additional feature data may also be provided at the input layer. Using the trained weights, values, and mathematical relationships between nodes in the input layer and nodes in the hidden layers, encodings, embeddings, decisions, and other data and calculated representations from hidden layers may be generated as mathematical representations (e.g., vectors) of the input feature data. A first hidden layer may then be connected to second hidden layer, and so on for as many hidden layers are used or required, which may generate further encodings and/or embeddings of the feature data. These may be used may be used to create decisions, such as based on the trained weights and relationships between nodes, which are provided as output scores, values, or other data at the output layer. Using one-hot encoding or other data conversion operation, an output prediction may be provided as the output of DNN 300 based on the data from the output layer.

Initially after feature extraction and/or transformation for training the different DNN models and/or DNN 300, training data and a DNN architecture may perform cross validation, hyperparameter tuning, model selection, and the like for training DNN 300. When executing DNN 300, feature transformation may then be used with the input data and DNN 300 to generate a prediction, classification, and/or categorization, which may correspond to a predictive score or probability associated with the input data. The input data may correspond to one or more data records from sequences of events that have been generated and/or encoded for input, which each having different input features having a number of features. In DNN 300, the input features may correspond to main forecasted feature(s). For example, input sequence 302 may include encoded sequences from a transaction history in a sequence 304, where 0 represents a transaction not occurring and 1 represents a transaction as occurring at different times or timesteps (e.g., each hour or day over a time period for sequence 304). Sequence 304 may therefore correspond to an encoded sequence representing the occurrence of an event and/or data calls for the event (e.g., API requests to external services for data).

Sequence 304 may then be sectioned or portioned into individual smaller sequences that may be used as sequence inputs for sequence-based forecasting of future events. For example, each sequence may represent three timesteps in diagram 300, such as a three-day period or window where transaction processing or other events occur that are relevant to the output event and data call predictions. For example, to calculate time and sequence-based forecasting based on temporal data, where the data may change and/or be measured at different times in a look-back period, sequences for the selected time period or window are used. Convolution layers 306 may take, as input, these sequences generated and/or encoded from sequence 304, which may then process the data and determine a vector, embedding, encoding, or other data representation used by RNN 308 to perform sequence-based future event forecasting based on occurrences of the event at different times during sequence 304. Thus, convolution layers 306 may process the initial input sequences prior to providing to LSTM for individual outputs that are then used for determination of outputs 312. Although two outputs (e.g., two label outputs) are shown, more general outputs may be provided, such as single outputs or single labels, multi-labeled outputs having more than two labels, and the like.

Outputs from RNN 308 for each sequence's input from convolution layers 306 may then be concatenated in a fully connected layer 310, which may then provide outputs 312. Outputs 312 may be used for forecasting and/or predicting of future events and there corresponding required data calls in order to batch process and execute those data calls in a predictive manner prior to occurrence of the events and/or use or requirement of the corresponding data from the data source (which may be internal or external and introduce latency, delay, and/or additional processing and network resources to call, request, and/or process). With seq2seq models, an output may correspond to an embedding or vector, which may more easily be used when determining the model output. Thus, the output may not be the decision or prediction but instead a condensed version of the data in a hidden state that may be provided for use with RNN 308.

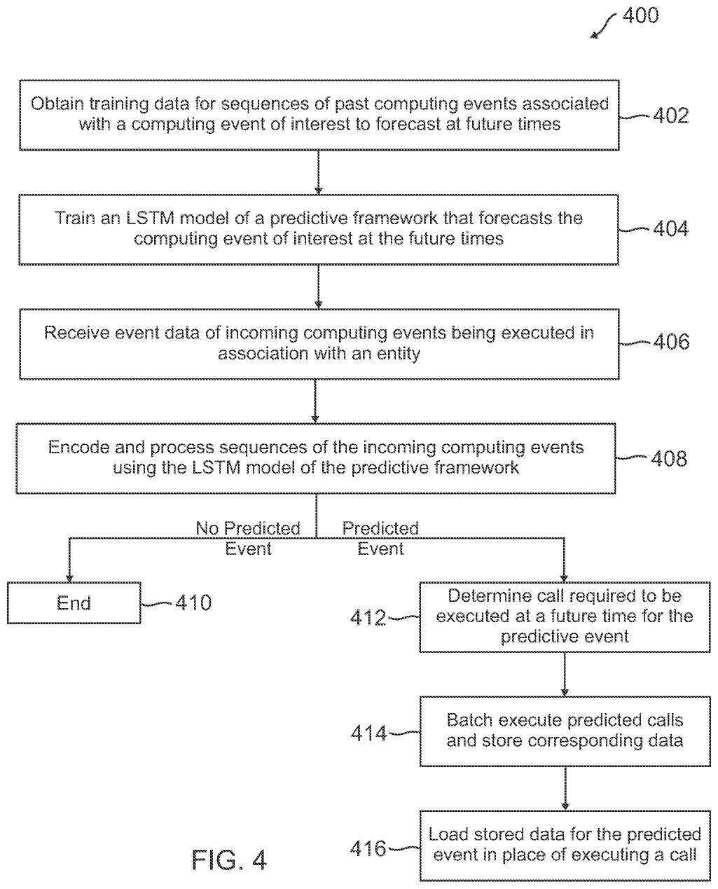

FIG. 4 is a flowchart 400 for reducing latency through automated sequence-based propensity models that predict external data calls, according to an embodiment. Note that one or more steps, processes, and methods described herein of flowchart 400 may be omitted, performed in a different sequence, or combined as desired or appropriate.

At step 402 of flowchart 400, training data is obtained for sequences of past computing events associated with a computing event of interest to forecast at future times. In order to train the DNN model or system, such as using a LSTM recurrent neural network architecture, training data may be determined, which may correspond to input data utilized for an output prediction or classification. The training data may correspond to a particular set of data, such as data tables having rows for different data records of one or more events, users, entities, accounts, or activities, and columns for one or more features in a set of features that have been selected and/or determined using feature engineering and extraction for training the DNN model. For example, the features may be associated with sequence-based occurrences of past events that are associated with an entity, where the events may correspond to data processing requests, executions, and the like. In some embodiments, the events may be associated with electronic transaction processing requests, authentications, risk analysis, fraud detection, and the like. The training data may correspond to a feature or variable that is to be forecasted at a future time, such as an event for a user, account, entity, or the like that may be predicted to occur at a future time.

At step 404, an LSTM model of a predictive framework is trained to forecast the computing event of interest at the future times. An LSTM or other DNN model may be trained based on the training data and sequences of past events that have been generated from the training data. For example, the sequences may correspond to sequences of days where the event occurred or did not occur, such as three-day sequences each encoded with a representation (e.g., 0 or 1 with binary yes/no of event occurrence) of whether the event occurred. When training the DNN model, hidden layers of each DNN model may be trained, adjusted, and/or have nodes reweighted. Further, other events and/or data processing requests associated with the event for forecasting may also be sequenced and used as training data. For example, an account balance inquiry, account authentication or login, or the like may be sequenced when predicting whether a user may engage in processing a transaction at a future time. The sequences and/or event may be selectable by a data scientist and/or modeler based on data that may affect the feature or variable for forecasting.

At step 406, event data of incoming computing events being executed in associated with an entity are received. The event data may correspond to data for the input features (e.g., the feature or variable being forecasted at a future timestep), as well as sequences of such events, requests, or other data that may be sequenced and used for the input features. In some embodiments, the feature data may correspond to data over a previous time period, which includes multiple times or timesteps that allow for sequencing of data into sequences that may be processed by the LSTM model or other DNN. For example, the feature data may include whether certain events occurred at each minute, hour, day, or the like over a time period that is to be analyzed for prediction of a future event. The incoming computing events may therefore correspond to activities, requests, data calls, and the like that may be performed, detected, and/or requested by the service provider's computing system over a time period and used by the LSTM model or other DNN for event forecasting and predicting.

At step 408, sequences of the incoming computing events are encoded and processed using the LSTM model of the predictive framework. The incoming computing events may be used to encode data sequences for specific time intervals and/or sequences of times or time-steps where the incoming computing events occurred, did not occur, or otherwise were managed (e.g., may be continuing to be processed, loaded but not processed, etc.). Processing of the sequences may include determination of whether a future event is predicted based on the sequenced data for the incoming computing events. For example, a first predictive forecast of the feature or variable (e.g., the event) is determined using the feature data and the DNN model. Feature extraction on the feature data may be performed and an input layer of the DNN model may take the data for the features and process using the hidden layers to provide a predictive forecast at an output layer. To provide this forecast, the DNN model, such as an LSTM recurrent neural network architecture, may process the feature data at each previous time consecutively or in series as a sequence (e.g., successively in the look-back period and proceeding successively through the next times).

At step 410, if no predicted event is determined, predicted, and/or output with a high enough likelihood of occurrence, the process ends. However, if an event is predicted (e.g., determined to be likely to occur to a score, value, or other predictive output that meets or exceeds a threshold likelihood of occurrence), then flowchart 400 proceeds to step 412. At step 412, a call required to be executed at a future time for the predicted event is determined. A ML engine may also predict which data calls are required by events, such as based on past data calls, when the events are occurred. Thus, the LSTM models may also or instead be trained to predict the data calls based on training data for past occurrences of data calls that occurred or are associated with events and executed to provide, retrieve, load, and/or process data for the events.

At step 414, predicted calls are batch executed and corresponding data is stored. The predicted calls may be collected, aggregated, or otherwise joined into a batch processing job, which may be executed at specific times, when the batch becomes of a certain size or numerosity of data calls, and/or at a time prior to the occurrence of the corresponding events requiring data from executing the predicted data calls. At step 416, stored data for the predicted event is loaded in place of executing a call, such as an API data request or other call for data needed by the predicted event. This may be loaded instead of executing the data call at the time of the predicted event, thereby reducing latency, conserving network and processor resources, and otherwise providing faster computing response times and data processing. This further frees network channels and communications, as well as corresponding processors and computing services, from being required to execute data calls during the event, which improves the processing speed and availability of computing systems when processing data requests and other data processing events with entities.

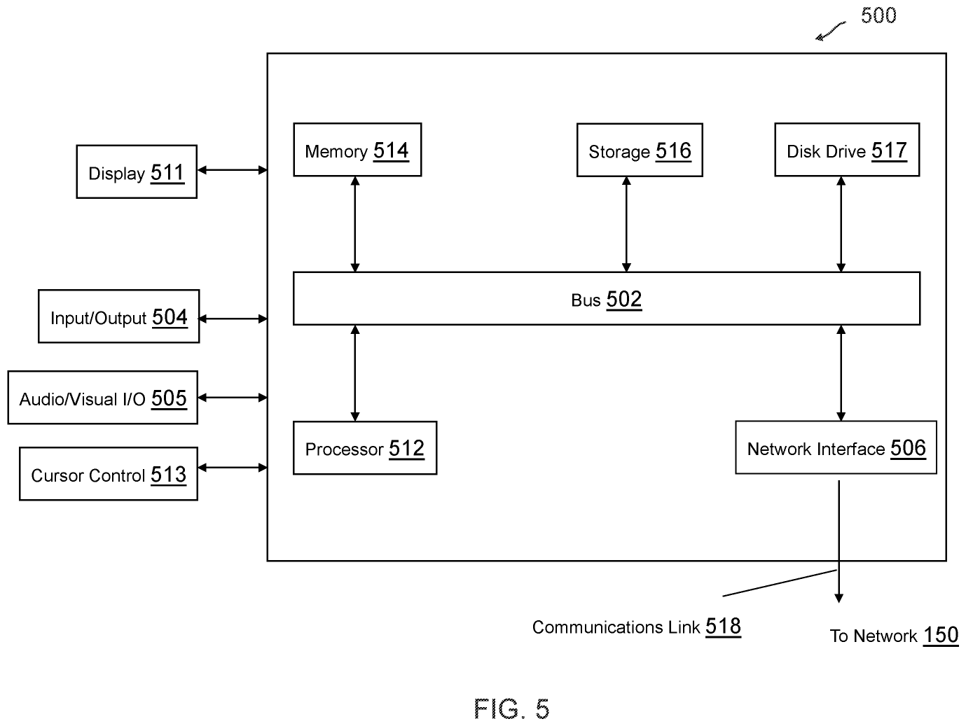

FIG. 5 is a block diagram of a computer system 500 suitable for implementing one or more components in FIG. 1, according to an embodiment. In various embodiments, the communication device may comprise a personal computing device e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 150. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A service provider system comprising:
a non-transitory memory; and
one or more hardware processors coupled to the non-transitory memory and configured to read instructions from the non-transitory memory to cause the service provider system to perform operations comprising:
obtaining input feature data for an entity, wherein the input feature data is associated with sequence-based data for neural network features over a past time period;
executing a predictive call execution framework comprising a deep neural network model trained for forecasting of future events associated with the entity, wherein the deep neural network model is trained using training data associated with the neural network features for event sequences from past events associated with the entity;
determining a first predictive forecast of one of the future events for the entity at a future time using the input feature data and the deep neural network model; and
adding, based on the first predictive forecast, an API call for data from an external computing service to a batch processing event, wherein the data is usable for the one of the future events at the future time.

2. The service provider system of claim 1, wherein the deep neural network model comprises a long short-term memory (LSTM) architecture, gated recurrent unit (GRU) architecture, or other recurrent neural network (RNN) architecture trained using a plurality of event sequences encoded from occurrences of past events associated with the future events to be forecasted, and wherein the deep neural network model uses one-dimensional convolutional layers with the LSTM architecture, the GRU architecture, or the RNN architecture.

3. The service provider system of claim 1, wherein the sequence-based data comprises time-based data of computing events executed by the entity over the past time period using a computing service of the service provider system provided to the entity.

4. The service provider system of claim 1, wherein the operations further comprise:
executing the batch processing event with the external computing service for the API call;
storing the data for the one of the future events detecting a computing operation occurring that is associated with the one of the future events;
retrieving the stored data; and
loading the stored data to at least one downstream computing service during the one of the future events.

5. The service provider system of claim 1, wherein the input feature data comprises data corresponding to at least one string of computing events processed for the entity during the past time period, and wherein the operations further comprise:
encoding the data corresponding to the at least one string of computing events from at least one sequence of computing events occurring during the past time period and the neural network features.

6. The service provider system of claim 1, wherein the future events are associated with one of a transaction processing request, an account authentication request, or a network token fetching request, and wherein the API call comprises one of a bank account balance inquiry from an open source banking data platform, a network token prefetch request from a network token service provider, an available fund balance inquiry, an authentication confirmation, or a risk analysis.

7. The service provider system of claim 1, wherein the predictive call execution framework comprises one or more modules that are implemented with downstream services of the service provider system that provides stored data in real-time during the one of the future events at the future time.

8. The service provider system of claim 1, wherein prior to obtaining the input feature data, the operations further comprise:
training the deep neural network model using a first portion of training data associated with the neural network features and an LSTM architecture, GRU architecture, or RNN architecture with one-dimensional convolutional layers; and
testing the deep neural network model for deployment with the predictive call execution framework using a second portion of the training data.

9. The service provider system of claim 8, wherein the training and the testing are performed using the training data specific to at least one of the entity or an event type that is designated for the forecasting of the future events based on sequences of other events occurring in a temporal association with each of the other events.

10. The service provider system of claim 8, wherein prior to the training, the operations further comprise:
generating training sequences of events from the training data and the network features; and
converting the training sequences to vectors,
wherein the training is performed using at least the vectors.

11. A method comprising:
determining, using a deep neural network model of a predictive framework configured to enable sequence-based forecasting of future events using external data calls, a plurality of past events for an entity over a time period, wherein the plurality of past events include feature data for features processed by the deep neural network model;
determining, using the deep neural network model, a first predictive forecast of a first future event at a first future time after the time period based on the feature data;
determining a first external data call required for the first future event based on at least one of the plurality of past events;
executing the first external data call to a first external service prior to the first future time, wherein the first external service includes data used during the first future event;
receiving the data from the first external service based on the executing; and
storing the data for the first future time of the first future event.

12. The method of claim 11, wherein the deep neural network model is trained using a long short-term memory (LSTM) algorithm, gated recurrent unit (GRU) algorithm, or other recurrent neural network (RNN) algorithm with one-dimensional convolutional layers for the sequence-based forecasting of the future events based on past sequences of events associated with past executions of the external data calls, and wherein, prior to the determining the plurality of past events, the method further comprises:
executing the predictive framework for the entity based on the entity utilizing a computing service associated with the first future event.

13. The method of claim 11, wherein the executing the first external data call comprises executing a batch processing operation including the first external data call, wherein the batch processing operation comprises using at least a portion of the external data calls that are processed prior to the future events.

14. The method of claim 13, further comprising:
determining, using the deep neural network model, a second predictive forecast of a second future event at a second future time after the time period based on the feature data, wherein the second future event occurs after the first future event with a computing service provided to the entity; and
determining a second external data call required for the second future event based on at least one of the plurality of past events,
wherein the executing the batch processing operation includes executing the second external data call with the first external data call.

15. The method of claim 11, further comprising:
retrieving, at the first future time, the stored data for the first future event; and
loading the stored data during a data processing operation for the first future event.

16. The method of claim 11, wherein prior to the determining the first predictive forecast, the method further comprises:
determining a plurality of vectors from sequences of the plurality of past events during different time intervals over the time period, wherein each of the plurality of vectors comprise encoded data identifying each of the sequences, and wherein the first predictive forecast comprises one of a vector or a score provided as an output from the deep neural network model that identifies a likelihood of occurrence of the first future event occurring.

17. A non-transitory machine-readable medium having stored thereon machine-readable instructions executable to cause a machine to perform operations comprising:
receiving training data for a recurrent neural network (RNN) model, wherein the training data comprising feature data for model features selected for the RNN model over a time period associated with a plurality of past computing events for an entity;
encoding the plurality of past computing events using the feature data;
training the RNN model using the training data and the encoding of the plurality of past computing events, wherein the RNN model is trained to enable predictive forecasting of a future computing event;
predicting the future computing event using the RNN model;
executing a computing call during a data processing of the future computing event on behalf of the entity; and
preloading, based on the executing the computing call, data for the data processing of the future computing event prior to an occurrence of the future computing event.

18. The non-transitory machine-readable medium of claim 17, wherein a predictive framework includes the RNN model and one or more operations that integrate outputs by the RNN model into a plurality of downstream services that utilize the data and additional data for predictive computing call executions by the predictive framework, and wherein the RNN model comprises one of a long short-term memory (LSTM) model or a gated recurrent unit (GRU) model that use one-dimensional convolutional layers.

19. The non-transitory machine-readable medium of claim 18, wherein the output comprises at least one of a regression output type or a classification output type associated with the future computing event, and wherein the outputs utilize at least one recurrent cell for the RNN model.

20. The non-transitory machine-readable medium of claim 17, wherein the operations further comprise:
detecting the occurrence of the future computing event; and
loading the data from a local storage for a computing service requiring the data for the data processing.
